(19) United States
(12) Patent Application Publication
(10) Pub. No.: US 2012/0045047 A1
(43) Pub. Date: Feb. 23, 2012

(54) Intelligent call routing

(76) Inventors: Tony John Million, London (GB); Philip Tee, Surrey (GB)

(21) Appl. No.: 13/211,942

(22) Filed: Aug. 17, 2011

Related U.S. Application Data
(60) Provisional application No. 61/374,366, filed on Aug. 17, 2010.

(51) Int. Cl. H04M 15/06

(52) U.S. Cl. 379/142.04

(57) ABSTRACT

A system routes a call from a Party A to Party B. The system includes a transport mechanism to route the call, a server coupled to the transport mechanism and to Party A and Party B, at least one database of at least one of Party A and Party B information and an interface. In response to a request by Party A to call Party B, the call is made between Party A and Party B, and Party B sees Party A's identification that need not be the same as a route the call has taken.

### CROSS-REFERENCE TO RELATED APPLICATIONS

This application claims the benefit of U.S. Application No. 61/374,336, filed Aug. 17, 2010, which application is fully incorporated by reference herein.

### BACKGROUND

1. Field of the Invention

The present invention is directed to call routing, and more particularly to a call routing system, and its methods of use, that route calls between a caller and a callee with the callee receiving the caller's identification that need not be reflective of the route that the call has taken.

2. Description of the Related Art

Telephone calls often need to be routed in accordance with callers' instructions. Calls typically are routed by a human operator or an automated call routing system (commonly referred to as an “automated attendant” or “auto attendant”). Human operators typically route calls accurately and efficiently, but at a relatively high cost. Auto attendant systems, on the other hand, typically are cheaper to implement, but tend to be less accurate and efficient than human operators. For example, some auto attendants present a caller with a hierarchical menu consisting of a list of choices through which the caller must navigate. Often, making a choice opens up a menu of further choices. In large organizations, the menu hierarchy may be very complex, requiring several choices by a caller, and requiring a caller to listen to a long menu list in order to understand the available choices. Navigating through such menu hierarchies typically is a frustrating and lengthy process for most callers and not very efficient.

Traditionally, auto-attendants play an announcement to the caller and prompt a caller to make one of multiple selections using a voice response unit. For example, the caller may be prompted to dial the extension of the party being called. The caller also may be given other options, such as leaving a voice message or accessing a directory of names if the extension of the called party is not known. Some early automated telephone directories required the caller to spell the name of the called party using a telephone dual-tone multifrequency (DTMF) keypad. Most recent auto-attendant systems are voice-enabled, allowing callers to be routed to a desired call destination simply by speaking the name of the call destination. In these systems, an auto-attendant answers an incoming call and asks the caller to speak the name of the party or department being called. The auto-attendant includes a speaker-independent speech recognition engine that identifies and translates a received speech signal into name data. The auto attendant obtains a telephone number corresponding to the translated name data from a telephone number directory based on the translated name data, and routes the call to that telephone number.

When a call destination name search provides an ambiguous result, some conventional auto-attendant systems rely on the caller's ability to distinguish between parties based on telephone numbers or other information. These systems become increasingly more cumbersome as the number of similar names that are maintained in the call destination directory increases. Other auto-attendant systems use secondary information that is contained in subscriber listings to disambiguate search results and provide the telephone number and other data that are associated with a desired party.

There is a need for, a call routing system that allows an outgoing call from a caller (Party A) to a callee (Party B) to be diverted and use any available transport mechanism by an intermediary server before the call is setup.

### SUMMARY

An object of the present invention is to provide a call routing system, and its methods of use, where when the call is routed and the call made, Party's A identification is shown to Party B and the identification need not be reflective of the route the call has taken.

Another object of the present invention is to provide a call routing system, and its methods of use, where the “how” relative to Party A contacting Party B is provided, and when the call goes through, Party B sees Party A's identification information.

A further object of the present invention is to provide a call routing system, and its methods of use, that provides maintaining a consistent interface to the caller and calling ID to the callee so the callee sees a phone number or identity previously identified with the caller.

Still another object of the present invention is to provide a call routing system, and its methods of use, where the system selects the most relevant carrier.

Yet another object of the present invention is to provide a call routing system, and its methods of use, where the system uses PSTN, either cellular or a fixed LAND line, VOIP, either fixed or radio based, and the like, based on a pre-selected set of criteria.

Still another object of the present invention is to provide a call routing system, and its methods of use, that includes cost effectiveness and quality.

These and other objects of the present invention are achieved in a system that routes a call from a Party A to Party B that includes a transport mechanism to route the call, a server coupled to the transport mechanism and to Party A and Party B, at least one database of at least one of Party A and Party B information and an interface. In response to a request by Party A to call Party B, the call is made between Party A and Party B, and Party B sees Party A's identification that need not be the same as a route the call has taken.

In another embodiment, a method is provided that routes a call from Party A to Party B. A system is provided with a transport mechanism and a server coupled to the transport mechanism and to Party A and Party B. A request for a call is initiated by Party A to Party B. A route is selected for the call. Party A's identification is made to Party B when the call is made. The identification need not be reflective of the route taken for the call.

### BRIEF DESCRIPTION OF THE DRAWINGS

FIG. 1 is a diagram illustrating one embodiment of a system of the present invention that routes a call or other type of communication from Party A to Party B.

FIG. 2 is a flowchart that illustrates a user signing up and registers its relevant communication identifier with the system of the present invention.

FIG. 3 illustrates one embodiment of how a system of the present invention verifies that a communication number belongs to a user.

FIG. 4 illustrates one embodiment of the present invention showing how each device can register it's connectivity with a server of the system.

FIG. 5 illustrates one embodiment of the present invention where Party A desires to make a call to a 777 555-1212 and the server determines what device or Party is associated with that number.

FIG. 6 illustrates an embodiment of the present invention where Party B messages a server to place a call to Party C and based on the capabilities of B and C the server determines that the only way to make the call is via a VOIP gateway.

FIG. 7 illustrates an embodiment of the present invention where Party C wants to call Party A and the server determines that there are two call options, (i) use a cellular phone directly or (ii) call a local number with a less expensive forwarding.

FIG. 8 illustrates an embodiment of the present where the server recognizes two numbers as IDs for Party B.

FIG. 9 illustrates an embodiment of the present invention where if anyone calls any of Party B's identifiers, Party B will ring because B has multiple identifiers.

FIG. 10 illustrates an embodiment where Party B has two IDs and wants to call Party A, the server that there are two options, (i) VOIP (WiFi) and (ii) VOIP to the PSTN gateway, and the server chooses using VOIP via the internet which is the least expensive option.

FIG. 11 illustrates an embodiment of Party A calling and server determines that there are two options, (i) a direct call using VOIP or (ii) because Party A has PSTN, a local number, 415 555-0001, can be called and then which is then routed over VOIP.

FIG. 12 illustrates an embodiment of the present invention where the server determines that since the call is to Party B, which only has VOIP, and Party C only has PSTN capability, the only option is for Party C to call the system gateway which then dials Party B.

FIG. 13 illustrates an embodiment where Party has two numbers and uses one to call while the other one is displayed.

FIG. 14 illustrates an embodiment where Party A wants to call Party C and have its caller ID to be rewritten.

### DETAILED DESCRIPTION

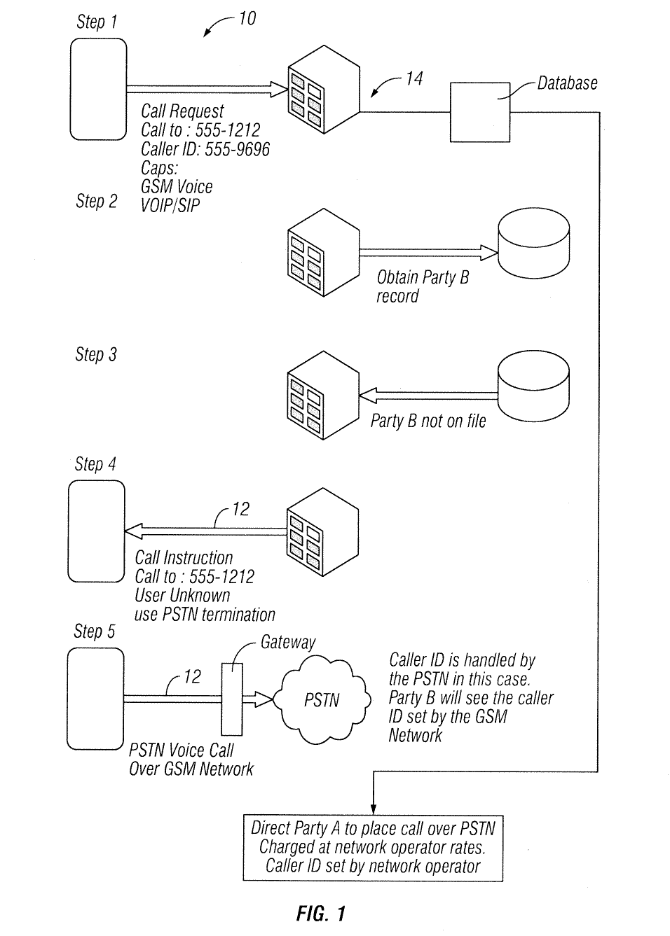

In one embodiment of the present invention, as set forth in FIG. 1, a system 10 is provided that routes a call or other type of communication (collectively a “call”) from Party A to Party B. The system includes a transport mechanism 12 to route the call. A server 14 is coupled to the transport mechanism 12 and to Party A and Party B. At least one database includes Party A and/or Party B information. In response to a request by Party A to call Party B, the call is made between Party A and Party B. Party B sees Party A's identification. The identification shown to Party B another caller IC that Party A has, another phone number that Party A has, and the like.

In one embodiment, Party A uses a first number to call Party B, and a second Party A number is displayed to Party B as the Party A identification. The route of the call can be made with or without knowledge of Party A.

As non-limiting examples, the transport mechanism 12 can be, 3G, 4G. WiFi, the internet, local radio communications, VOIP including VOIP over a wired connection, a connection to a regular telephone system, e.g., a physical telephone, and the like.

Transport mechanism 12 is selected from at least one of, VOIP, cellular communication, Land line and PSTN, for each PSTN option providing a choice of available carriers.

Server 14 can be a bank of servers and have directory functions in that it can maintain a directory of properties, transports, and identifications of the parties, e.g, Party B. As a directory server, server 14 is a known point where any party configured to use it can look up the directory information of the other party and pass the information on or contact the third party directory. Server 14 can also function as a rendezvous server that is in a known location and all parties can contact it because they have been registered selected information with server 14.

Server 14 determines where a user is, e.g., which networks the user is on, and also is a rendezvous server. That is, server 14 is the only know point to Party A and Party B. This is achieved while maintaining a consistent interface where Party A and Party B see the same thing. Party B sees the identifying information of Party A, e.g., phone number, and the like. In this manner, Party B sees a phone number or identity previously identified with Party A, and the route the call took is not visible to Party B.

With the present invention, system 10 provides the “how” relative to Party A contacting Party B, and when the call goes through, Party B sees Party A's identification information.

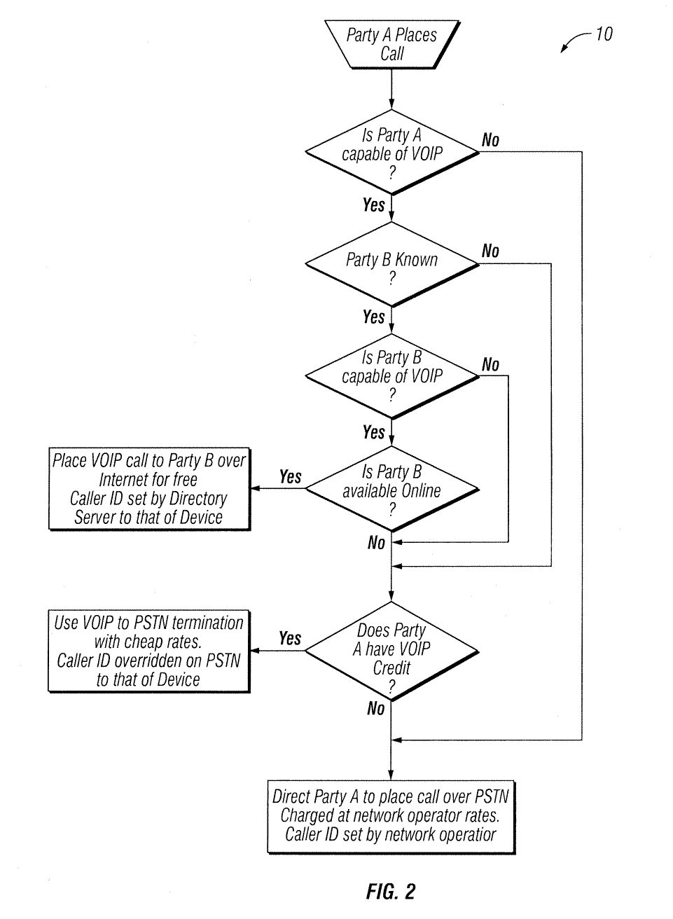

Referring now to the flowchart of FIG. 2, a user signs up and registers its relevant communication identifier, which is typically a phone number and hereafter referred to as a “phone number” but can also include any type of communication such as e-mail and the like. Once the number has been registered and verified it is used as a unique identifier in system 10 to identify that particular user. It is also used as the Caller ID for Party A.

During call setup, Party A wants to call Party B. Server 14 looks up all of the information it has regarding what networks B has, e.g., transport mechanisms. A transport mechanism is selected. Party A typically knows about this information first. The server 14 can have any information about Party B relative to the call, e.g., the e-mail address, Skype ID and the like.

Server 14 responds to Party A with the possible options on communication. Directory server 14 returns all of the options available for Party A to communicate with Party B, and the option is selected based on what Party A initially set up with system 10.

During call setup, Party A contacts server 14 and indicates an intent to place a call to Party B. As part of this communication, Party A transmits some type of unique identification information about Party B, including but not limited to telephone number. In addition, information regarding the device that Party A is using to make the communication with Party B is also sent. As a non-limiting example, these can include but are not limited to, ‘Supports GSM (3G) communication’, ‘Supports VOIP, and the like. These are typically the ‘Transports’ which Party A supports over which a communication with Party B that can be used for transmission. Included is information about Party A's network capabilities. e.g. whether Party A has 3G, 4G or WiFi capabilities and whether these are connected, are used to determine if a VOIP call is feasible.

When this information is received, server 14 looks up Party B and takes one of two actions: If Party B is not recognized in system 10, e.g., Party B has not registered with system 10, the server 14 compiles a list of calling options based upon the information Party A sent across. Because the directory server 14 has no other choice, these can be limited to PSTN supporting transports, including but not limited to, 3G Voice, VOIP with PSTN termination and the like i.e. any transport which can reliably terminated onto the Public Switched Telephone Network (PSTN). If Party B is a service user of system 10, then the server 14 investigates Party B's stored details as follows. The directory server determines if Party B has any ‘redirects’ set up, e.g, has Party B indicated how communications should be sent. This determination is important as in currently existing systems if Party B has a redirect, called Call Divert, set up then Party A pays for the call to Party B's initial number, and Party B pays for the part of the call from the original ‘Party B’ number to its divert number. By performing this redirect prior to initiating the call this results in a cost saving to Party B.

The server 14 then checks to see if Party B is available on-line and if so does Party B have the capability to receive a VOIP call, i.e. software support and appropriate network capabilities. If so then the server 14 instructs Party A and Party B to connect via the internet and use peer-to-peer VOIP so that neither of them pays for the call.

If Party B is not available online then directory server 14 determines if Party A has appropriate VOIP capabilities. If so and if Party A is subject to account credit checks, Party A is instructed to place the call over ‘VOIP with PSTN Termination’ to a location near Party B. From there the Caller ID at the telephone exchange is overridden to make it appear to Party B as if Party A is calling directly. The Caller ID seen is Party A's device.

Finally if Party B is not online, and Party A has no VOIP capability or has no account credit for a VOIP call, the directory server instructs Party A's device to place a PSTN call, which can be cellular, to Party B. The network operator is responsible for all voice transmission, Caller ID and billing.

In order to verify that a communication number, such as a phone number is owned by a user, system 10 communicates with the user on the communication number provided.

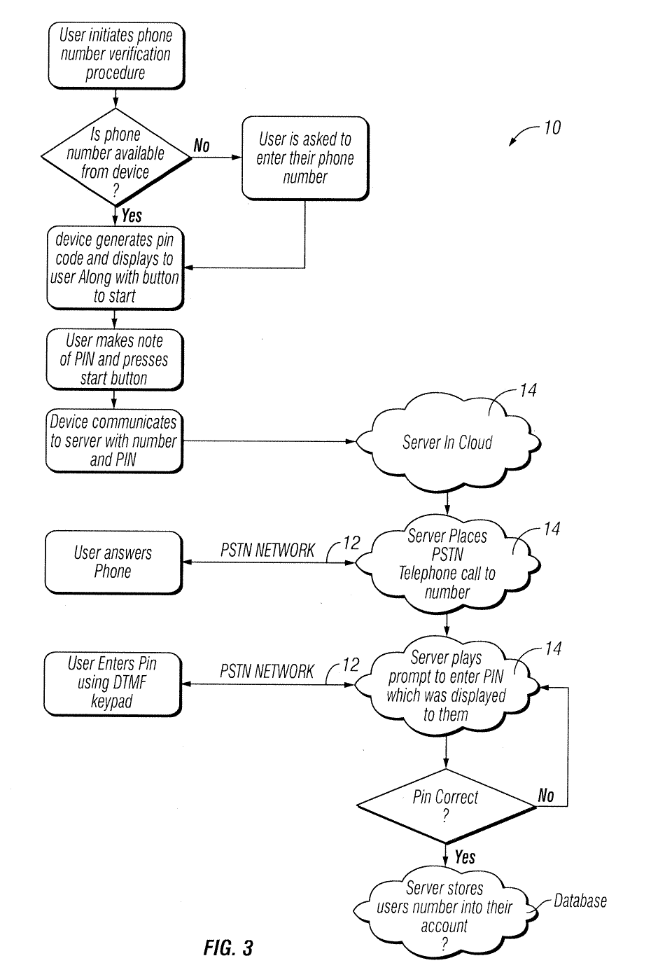

FIG. 3, illustrate how system 10 verifies that a communication number belongs to a user. The user first starts the registration process. If necessary the user is prompted to enter the communication number to be verified. The software client generates a PIN and displays it to the user informing the user to make a note of the PIN. Additionally, an interactive button is displayed on a display to proceed with the process.

When the button is pressed a request is sent to a server 14 with PSTN telephony capabilities. The request consists of the phone number to be verified and the PIN that is expected. Server 14 calls the given number and when answered plays a recording asking the user to ‘enter the PIN or hang up if they think the call was in error’. If the user is the legitimate owner of the PIN it receives the call and enters the correct pin. If the number the user tried to validate and it isn't theirs then someone else will receive the call and upon hearing the message will hang up. Server 14 logs the failed attempts and when a system defined number has a certain number of failed attempts, it does not proceed with the validation again without system manager intervention.

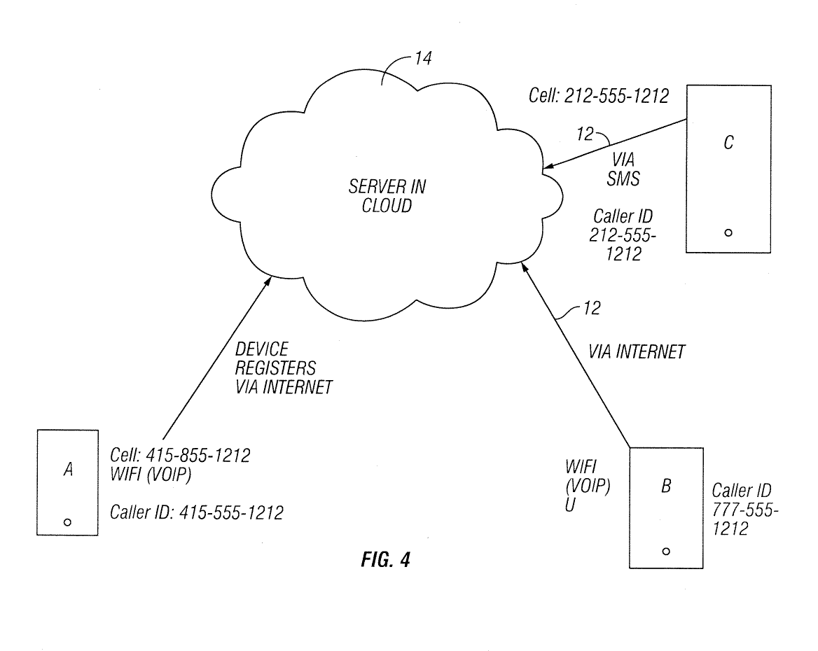

FIG. 4 illustrates how each device can register it's connectivity with server 14. In this embodiment, Party A has VOIP and PSTN (cellular) capability. Party A's caller ID is 415 555-1212 which is the PSTN. Party A has inter-connectivity and registers with server 14 via the internet. Party B only has VOIP and its caller ID is 777 555-1212. registers via the internet. Party C only has PSTN, no voice capability and has a cell number of 212 555-1212. It's caller ID is 212 555-1212. Party C registers with server 14 by sending an SMS message to server 14.

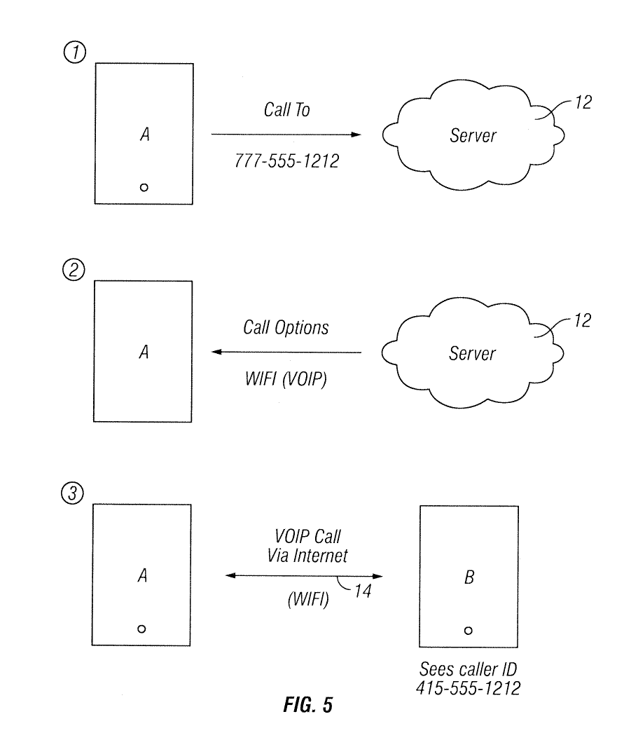

In the FIG. 5 embodiment, Party A desires to make a call to a 777 555-1212. Server 14 determines what device or Party is associated with that number. Server 14 determines to make a VOIP call and it is over WiFi. As illustrated in Step 3, Party A communicates with Party B via a VOIP call via the internet. Party B sees A's caller ID of 415-555-1212, which Party A has previously registered with server 14 as its ID.

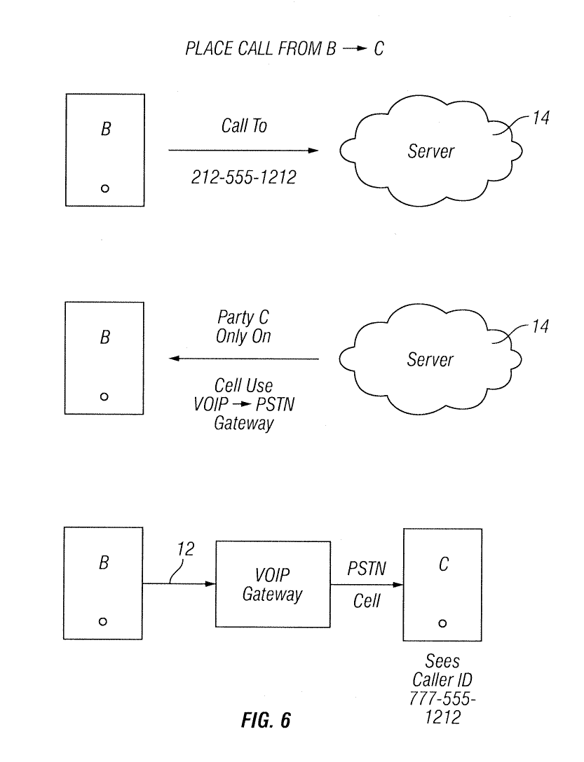

In the FIG. 6 embodiment, Party B makes a call to Party C's number of 212 555-1212. Party B does not have cellular capability and places the call to Party C. Party C has no VOIP capability. Party B messages server 14 that it wants to place a call to Party C's at 212 555-1212. Based on the capabilities of B and C, server 14 determines that the only way to make the call is via a VOIP gateway. Server 14 responds to Party B to use the VOIP to PSTN gateway for the call. B contacts the VOIP gateway which contacts C. Party C sees the original registered number of Party B, 777 555-1212.

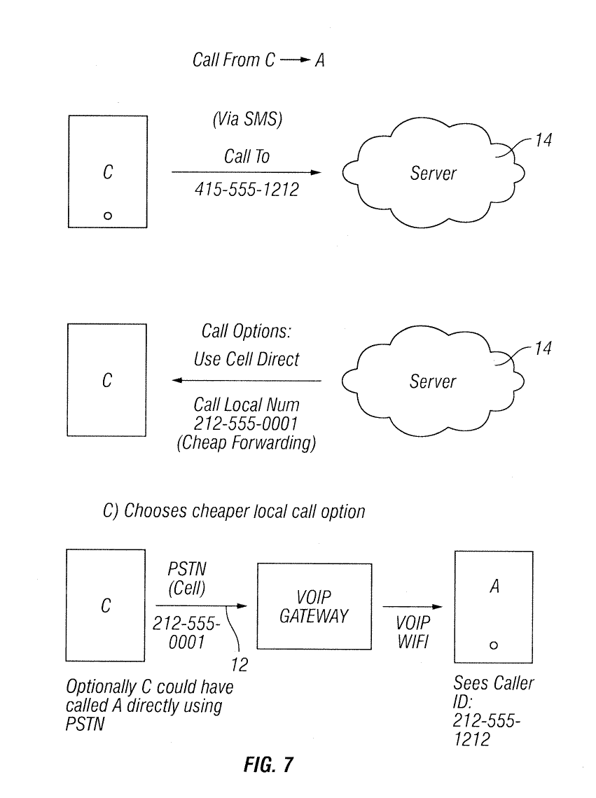

In the FIG. 7 embodiment, Party C calls Party A. Party C has only PSTN capability and contacts server 14 via an SMS message, indicating that it wants to place a call to 415 555-1212. Server 14 looks at the information relative to 415 555-1212 and makes a determination that there are two options: (i) use the cellular phone directly or (ii) call a local number, 212 555-0002 with a less expensive forwarding. Party C and Party A both have PSTN capabilities. C can call a local number that forwards the call on to A using VOIP because Party A also has VOIP capability. Party C selects the less expense VOIP option. Party A sees the caller ID of Party C, 212 555-0002, even though it is a VOIP call and C does not have any VOIP.

In the this embodiment, Party B has previously registered the number 777 555-1212 with server 14. Party B now registers a new U.K. number, 44 7900 1234 with server 14. Server 14 recognizes both numbers as IDs for Party B.

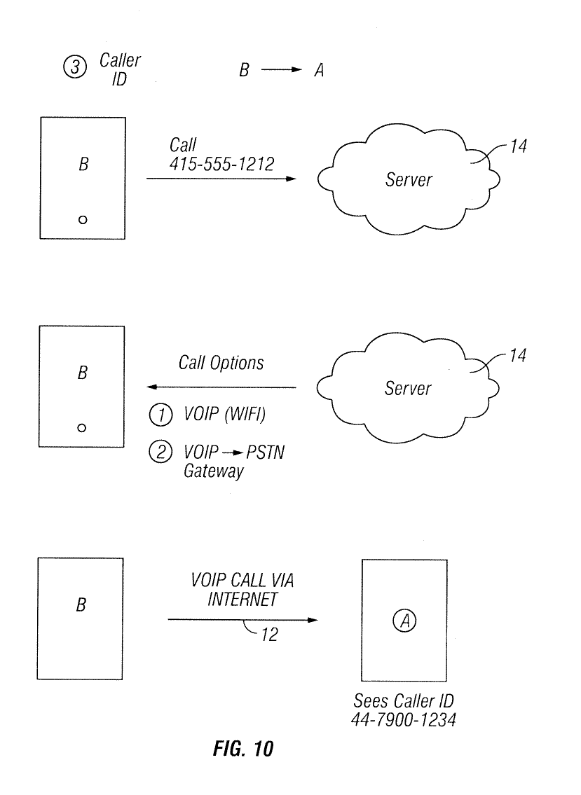

In the FIG. 9 embodiment, Party B sets its number of 44 7900 1234 with server 14 as its ID. Any Party called by Party B will see this number as Party B's ID. If anyone calls any of Party B's identifiers, Party B will ring because B has multiple identifiers. In the FIG. 10 embodiment, Party B has two IDs and wants to call Party A at 415 555-1212. Server 14 looks up 415 555-1212 determines it is Party A. Server 14 determines that there are two options, (i) VOIP (WiFi) and (ii) VOIP to the PSTN gateway. In this embodiment, server chooses using VOIP via the internet. Party A sees the caller ID set by B, 44 7900 1234, as Party B's caller ID. The selection of VOIP is the least expensive option.

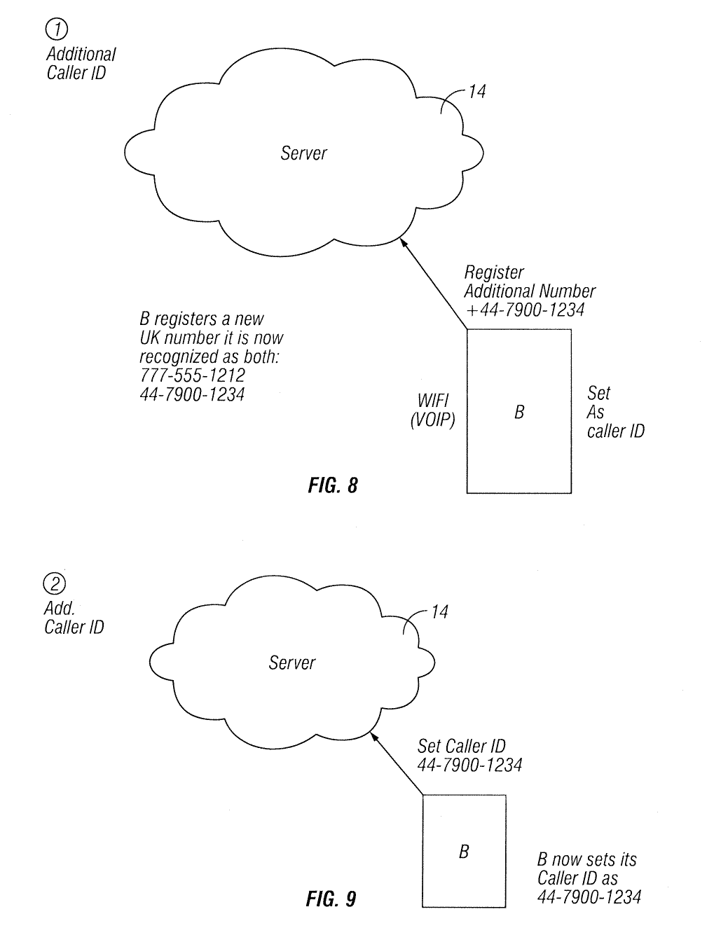

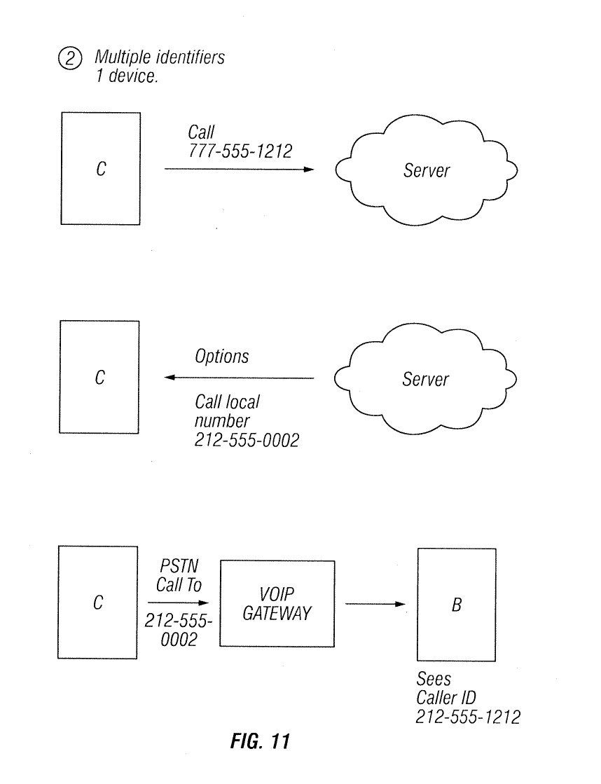

FIG. 11 illustrates an embodiment of Party A calling and server 14 looking up the called number 44 7900 1234, one of Party B's numbers, in FIG. 8. Server 14 returns two options, (i) a direct call using VOIP or (ii) because Party A has PSTN, a local number, 415 555-0001, can be called and then which is then routed over VOIP. Party A selects the local call number option because the quality of WiFi is low and decides to dial the PSTN number. The server gateway routes the call to B, and B sees A's ID of 415 555-1212.

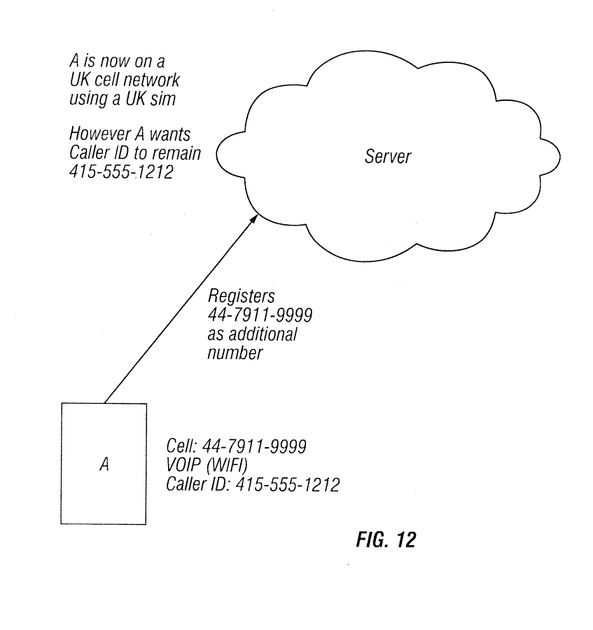

In FIG. 12, Party C calls 777 555-0002, server 14 looks this number up and determines it is associated with Party B. Server 14 then determines that since the call is to Party B which only has VOIP, and Party C only has PSTN capability, the only option is for Party C to call the system gateway which then dials Party B. Server 14 tells Party C to call the local number 212 555-0002 and the gateway then forwards the call to Party B. Party B sees the caller ID 212 555-0002, associated with Party C.

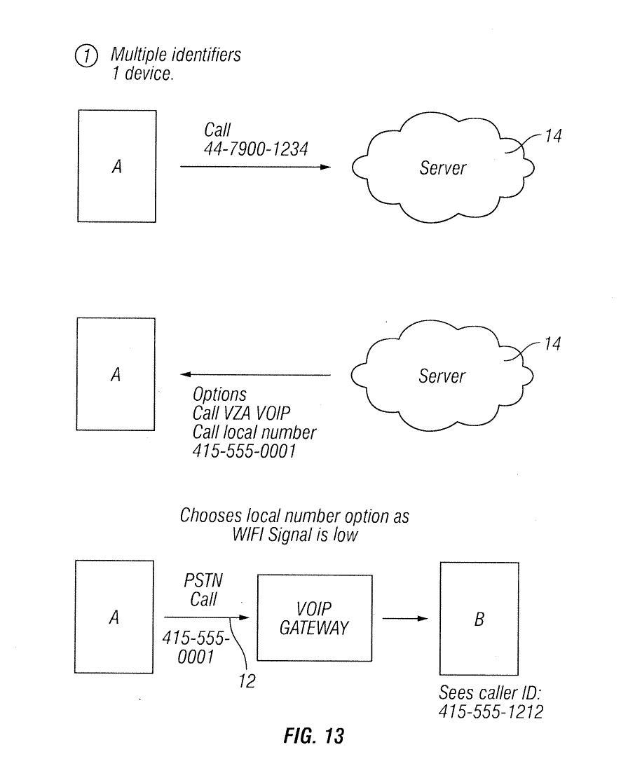

In the FIG. 13 embodiment, Party A obtains a U.K. SIM to put into its cellular device and is on a U.K. network but wants its caller ID to be 415 555-1212. Party A registers this new U.K. number at server 14. Party A now has two associated numbers. The U.K. number is the number of the device which has changed from the 415 number. When Party A makes a call using the U.K. number, server 14 shows the ID of Party A to be 415 555-1212. The carrier is selected by server 14.

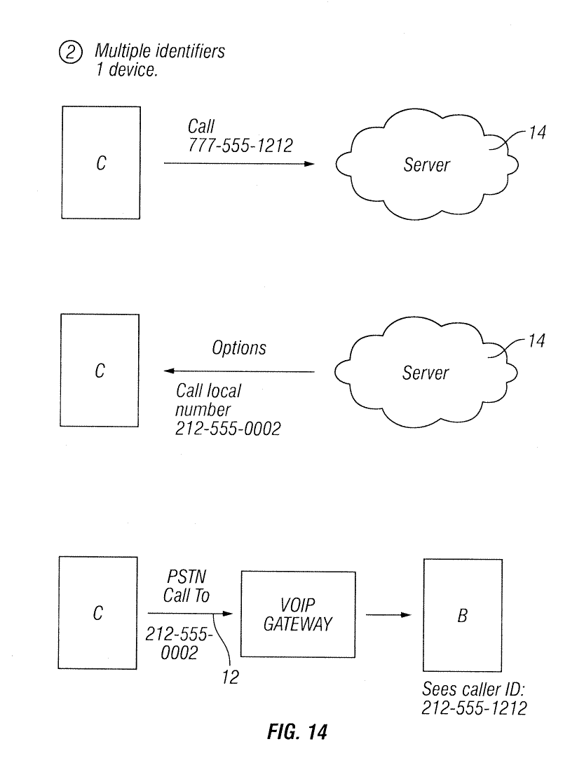

In the FIG. 14 embodiment, Party A wants to call Party C using the UK Sim, but wants its caller ID to be rewritten. In this embodiment, server 14 responds with a local number for the Gateway which when dialed forwards the call to Party C, rewriting the caller ID to be 415 555 1212 in the process.

Expected variations or differences in the results are contemplated in accordance with the objects and practices of the present invention. It is intended, therefore, that the invention be defined by the scope of the claims which follow and that such claims be interpreted as broadly as is reasonable.

1. A system that routes a call from a caller (Party A) to a callee (Party B), comprising:
a transport mechanism to route the call;
a server coupled to the transport mechanism and to Party A and Party B,
at least one database of at least one of Party A and Party B information;
an interface; and
wherein in response to a request by Party A to call Party B the call is made between Party A and Party B, and Party B sees a Party A identification that need not be reflective of a route the call has taken.

2. The system of claim 1, wherein Party A uses a first number to call Party B, and a second Party A number is displayed to Party B as the Party A identification.

3. The system of claim 1, wherein the route of the call is made with our without knowledge of Party A.

4. The system of claim 1, wherein in selecting the transport mechanism, the system includes cost effectiveness and quality.

5. The system of claim 1, wherein a transport mechanism is selected from at least one of, VOIP, cellular communication, LAND line and PSTN, for each PSTN option providing a choice of available carriers;

6. The system of claim 4, wherein the server is a know point to Party A and Party B.

7. The system of claim 1, wherein the interface is a consistent interface where Party A and Party B see the same thing.

8. The system of claim 1, wherein Party B sees identifying information of Party A.

9. The system of claim 1, wherein a route taken by the communication is not visible to Party B.

10. The system of claim 1, wherein the server determines which network or transport mechanism a user is on.

11. The system of claim 1, wherein the server also functions as an intermediary server.

12. The system of claim 11, wherein in response to a call setup, the server accesses a database to determine B's networks.

13. The system of claim 11, wherein the server is configured to access information about Party B from a database selected from at least one of, e-mail address and Skype ID.

14. The system of claim 1, wherein the server is configured to respond to Party A with communication options for communication with Party B.

15. The system of claim 1, wherein the system selects a communication option with Party B in response to information provided by Party A and found in the database.

16. The system of claim 1, wherein during a call setup, the server is configured to be contacted by Party A and receive by Party a unique identification information for Party B.

17. The system of claim 16, wherein during a call setup the server is configured to receive from Party A information regarding the type of device Party A is using to communicate with Party B.

18. The system of claim 17, wherein the information regarding the type of device includes transport information that Party A supports which can be used for communication transmission with Party B.

19. The system of claim 12, wherein when Party B is not recognized in the system, the server is configured to compile a list of calling options based on the information Party A sent across.

20. The system of claim 16, wherein the calling options are Public Switched Telephone Network (PSTN) supporting transports.

21. The system of claim 12, wherein when Party B has provided information to the system, the server is configured to determine if Party B has indicated how communications should be sent as a redirect.

22. The system of claim 21, wherein in response to Party's B redirect, the system performs the redirect prior to initiating a communication between Party A and Party B resulting in a cost saving to Party B.

23. The system of claim 21, wherein when Party B is available on-line and has a capability to receive a VOIP then the server instructs Party A and Party B to connect via the internet and use peer-to-peer VOIP.

24. The system of claim 12, wherein when Party B is not available online then the server is configured to determine if Party A has VOIP capabilities.

25. The system of claim 24, wherein when Party A has VOIP capabilities and is subject to account credit checks, the server is configured to instruct Party A to communicate with Party B over VOIP with PSTN Termination' to a location near Party B.

26. The system of claim 12, wherein when Party B is not online, and Party A has no VOIP capability or has no account credit for a VOIP call, the server is configured to instruct Party A's device to place a cellular PSTN call to Party B.

27. The system of claim 12, wherein the system is configured to certify that a communication number is owned by a user.

28. A method for routing a call between Party A and Party B, comprising:
providing a system with a transport mechanism and a server coupled to the transport mechanism and to Party A and Party B,
initiating a request for a call by Party A to Party B;
selected a route for the call; and
communicating Party A's identification to Party B when the call is made where the identification need not be reflective of the route taken for the call.

29. The system of claim 28, wherein Party A uses a first number to call Party B, and a second Party A number is displayed to Party B as the Party A identification.

30. The system of claim 28, wherein the route of the call is made with our without knowledge of Party A.

31. The method of claim 28, further comprising:
preventing a route taken by the communication to be visible to Party B.

32. The method of claim 1, wherein the server also functions as an intermediary server.

33. The method of claim 32, further comprising:
in response to a call setup, the server accesses a database to determine Party B's networks.

34. The method of claim 32, further comprising:
using the server to access information about Party B from a database selected from at least one of, e-mail address and Skype ID.

35. The method of claim 1, further comprising:
using the server to respond to Party A with communication options for communication with Party B.

36. The method of claim 28, further comprising:
using the system to select a communication option with Party B in response to information provided by Party A.

37. The method of claim 28, further comprising:
during a call setup using the server to be contacted by Party A and receive by Party A a unique identification information for Party B.

38. The method of claim 37, further comprising:
during a call using the server to receive from Party A information regarding the type of device Party A is using to communicate with Party B.

39. The method of claim 38, further comprising:
using information regarding the type of device includes transport information that Party A supports which can be used for communication transmission with Party B.

40. The method of claim 28,
in response to Party B is not recognized in the system, using the server to compile a list of calling options based on the information Party A sent across.

41. The method of claim 40, wherein the calling options are Public Switched Telephone Network (PSTN) supporting transports.

42. The method of claim 28, further comprising:
using the server to determines if Party B has indicated how communications should be sent as a redirect when Party B has provided information to the system

43. The method of claim 42, further comprising:
in response to Party B's redirect, performing the redirect prior to initiating a communication between Party A and Party B resulting in a cost saving to Party B.

44. The method of claim 42, further comprising:
having the server instruct Party A and Party B to connect via the internet and use peer-to-peer VOIP when Party B is available on-line and has a capability to receive a VOIP

45. The method of claim 43, further comprising:
having the server determine if Party A has VOIP capabilities when Party B is not available online.

46. The method of claim 45, further comprising:
using the server to instruct Party A to communicate with Party B over ‘VOIP with PSTN Termination’ to a location near Party B when Party A has VOIP capabilities and is subject to account credit checks.

47. The method of claim 28, further comprising:
using the server to instruct Party A's device to place a cellular PSTN call to Party B when Party B is not online, and Party A has no VOIP capability or has no account credit for a VOIP call,

48. The method of claim 28, further comprising:
verifying that a communication number is owned by a user.
